(19) United States
(12) Patent Application Publication
(10) Pub. No.: US 2016/0155101 A1
(43) Pub. Date: Jun. 2, 2016

(54) LOCATION BASED MERCHANT CREDIT VOUCHER TRANSACTIONS

(71) Applicant: ZEEK MOBILE LTD., Tel-Aviv (IL)

(72) Inventors: Daneil ZELKIND, Tel-Aviv (IL); Itay EREL, Tel-Aviv (IL); Ziv ISAIAH, Tel-Aviv (IL)

(21) Appl. No.: 14/906,601

(22) PCT Filed: Jul. 22, 2014
(86) PCT No.: PCT/IL14/50666

§ 371 Date: Jan. 21, 2016

Related U.S. Application Data
(60) Provisional application No. 61/856,776, filed on Jul. 22, 2013.

(51) Int. Cl. G06Q 20/04; G06Q 50/00; G06Q 20/32; G06Q 20/40; G06Q 30/06; G06Q 20/34

(52) U.S. Cl. CPC G06Q 20/0453; G06Q 30/0635; G06Q 30/0609; G06Q 20/342; G06Q 20/3276; G06Q 20/3224; G06Q 20/405; G06Q 50/01

(57) ABSTRACT

There is provided a method for location based purchase of merchant credit vouchers, comprising: gathering merchant credit vouchers from sellers; mapping each respective merchant credit voucher to at least one geographical redeeming area; receiving a geographical location of a user; matching the user geographical location to a certain geographical redeeming area from the geographical redeeming areas to identify a group of merchant credit vouchers redeemable with at least one merchant located within the geographical redeeming area of the user; receiving a purchase order for purchase of at least one of the merchant credit vouchers from the group; transmitting a digital representation of the purchased merchant credit voucher to the mobile client terminal for payment by the user at the merchant; and crediting an account of the user and debiting an account of a seller of the purchased at least one merchant credit voucher after the transmission of the digital representation.

### RELATED APPLICATION

This application claims the benefit of priority under 35 USC §119(e) of U.S. Provisional Patent Application No. 61/856,776 filed Jul. 22, 2013, the contents of which are incorporated herein by reference in their entirety.

### BACKGROUND

The present invention, in some embodiments thereof, relates to methods and systems for merchant credit voucher transactions and, more specifically, but not exclusively, to methods and systems for location based merchant credit voucher transactions.

Gift cards may be provided as presents instead of giving money or specific items, for example, a parent buys a $50 gift card to a certain bookstore, and gives the gift card as a gift for a child's birthday. The child may spend the $50 in any way, but is limited to the bookstore. Gift cards are physical items, paper or plastic based, with a means for identifying the amount of money that they store. Gift cards may only be used in the store that issued the gift card. As such, the recipient may not find any item of interest in the store accepting the gift card.

Different methods exist for exchanging one gift card redeemable at one store to another gift card redeemable at another store.

JOA et al., in United States Patent Application Publication No. 2013/0254074 describes “Systems, apparatus, methods, and computer program products for gift card exchange. The gift card holder is able to exchange either the full purchased amount or a residual balance amount. In other embodiments, a gift card exchange marketplace is provided to allow gift card exchange amongst gift card holders. Thus, gift card exchange alleviates the problem of undesired gift cards (i.e., gift cards from merchants that the recipient does not prefer). Moreover, gift card exchange of residual balances eliminates the problem related to unknown residual gift card balances and keeping track and possession of multiple gift cards with minimal residual balances.”

### SUMMARY

According to an aspect of some embodiments of the present invention there is provided a computerized method for location based purchase of merchant credit vouchers, comprising: gathering, at a central server, multiple merchant credit vouchers from multiple sellers; mapping, by the central server, each respective merchant credit voucher to at least one geographical redeeming area, wherein the multiple merchant credit vouchers mapped to geographical redeeming areas are stored in a database; receiving, at a central server, a geographical location of a user, the geographical location received from a mobile client terminal of the user; matching, at the central server, the user geographical location to a certain geographical redeeming area from the geographical redeeming areas within the database to identify a group of merchant credit vouchers redeemable with at least one merchant located within the geographical redeeming area of the user; transmitting, from the central server to the mobile client of the user, the identified group of merchant credit vouchers; receiving, at the central server, a purchase order for purchase of at least one of the merchant credit vouchers from the group; transmitting a digital representation of the purchased at least one merchant credit vouchers to the mobile client terminal for payment by the user at the merchant; and crediting an account of the user and debiting an account of a seller of the purchased at least one merchant credit voucher after the transmission of the digital representation.

Optionally, the method further comprises processing the geographical location to identify the user during a shopping trip based on the user being located within a shopping complex.

Optionally, the purchase order and transmitting the digital representation are performed as the user is located within a physical store of the merchant or directly in front of the entrance to the physical store, before redeeming the at least one merchant credit voucher at the physical store of the merchant.

Optionally, the group of identified merchant credit vouchers is transmitted to the user as the user is located within a shopping complex including multiple merchants having physical stores, the list including at least some credit vouchers redeemable at respective merchants of the multiple merchants within the shopping complex.

Optionally, transmitting the group is performed using a push notification application to the mobile client.

Optionally, the method further comprises analyzing changes in the geographical location of the user, and generating different groups of credit vouchers for merchants in shopping proximity to the user as the user changes locations.

Optionally, the group includes at least one merchant credit voucher owned by the user, and further comprising transmitting a reminder alert to the user to shop using the respective user owned at least one merchant credit voucher when the user is in shopping proximity to the respective merchant.

Optionally, the group includes at least one merchant credit voucher owned by the user, and further comprising transmitting a reminder alert to the user to shop using the respective user owned at least one merchant credit voucher based on the expiration date, to remind the user to redeem the credit voucher before expiration.

Optionally, the group includes at least one merchant credit voucher offered for sale by the respective merchant, at the physical store of the respective merchant in shopping proximity to the user.

Optionally, the at least one merchant credit voucher is a store credit based on a returned store item.

Optionally, the at least one merchant credit voucher is a merchant issued coupon.

Optionally, matching further comprises identifying at least one merchant credit voucher redeemable with at least one merchant located in shopping proximity to said user based on a user preference shopping profile, so that the at least one merchant includes items of interest to the user based on the user preference shopping profile.

Optionally, matching further comprises identifying at least one merchant credit voucher redeemable with at least one merchant located in shopping proximity to said user based on an analysis of at least one social network the user has joined, so that the at least one merchant includes items of interest to the user based on the analyzed at least one social network.

Optionally, the merchant credit voucher is offered for sale at a discount to a face value of the merchant credit voucher, and the face value, a discounted price, and the discounted percentage are presented to the user at the mobile device.

Optionally, the method further comprises analyzing the geographical location as an orientation vector pointing along the user's walking path to a store location of said at least one merchant.

Optionally, the method further comprises receiving, a geographical location of the seller from a mobile client terminal of the seller; analyzing the geographical location of the user and the seller to determine concurrent geographical locations in shopping proximity of the user and the seller, and sending a message to the user and the seller to arrange a face to face meeting between the user and seller for purchase of a physical version of the at least one merchant credit voucher. Optionally, the geographical location of the seller is received and analyzed at one or both of the central server and the mobile client terminal of the user.

Optionally, the digital representation is generated by digitally photographing a paper based version of the at least one merchant credit voucher, by the mobile device of the seller.

Optionally, the at least one merchant credit voucher is purchased with money.

Optionally, the method further comprises analyzing the geographical location of the user to determine the location of the user within a physical store of a merchant or in front of the physical store; and matching to identify at least one merchant credit voucher redeemable at a competitor of the merchant, the competitor located in shopping proximity to said user, wherein the at least one merchant credit voucher is stored in the database of the multiple merchant credit vouchers being offered for sale.

Optionally, the method further comprises analyzing statistical data based on a market of the multiple merchant credit vouchers to calculated an estimated market price for one or more merchant credit vouchers of the multiple merchant credit vouchers; purchasing the one or more merchant credit vouchers at a price below the estimated market price; and selling the purchased one or more merchant credit vouchers at a price higher than the purchase price.

Optionally, the debiting an account of a seller is performed a period of time after crediting an account of the user, and after verifying proper receipt of the voucher by the seller. Optionally, money held after the crediting of the account is deposited with a financial institution to earn interest before debiting the account of the seller. Optionally, the credit voucher is donated by the seller, with proceeds from the sale going to a charity instead of to the respective seller.

Optionally, the geographical location includes a navigation route and end target destination provided by a navigation application on the mobile device of the user, and the matching is performed based on geographical location areas along the navigation route and end target destination.

According to an aspect of some embodiments of the present invention there is provided a system for location based sale of merchant credit vouchers, comprising: a central server, comprising: a hardware processor; and a memory in electrical communication with the processor, the memory having stored thereon: a credit voucher database storing multiple merchant credit vouchers gathered from multiple sellers, wherein each respective merchant credit voucher is mapped to at least one geographical redeeming area; a mobile client terminal interface configured for receiving a geographical location of a user, the geographical location received from a mobile client terminal of the user; a credit voucher module configured for matching, based on the user geographical location, to a certain geographical redeeming area from the geographical redeeming areas within the database to identify a group of merchant credit vouchers redeemable with at least one merchant located within the geographical redeeming area of the user; wherein the mobile interface is further configured for transmitting to the mobile client terminal of the user, the group of merchant credit vouchers; wherein the receiving interface is further configured to receive a purchase order for purchase of at least one of the merchant credit vouchers from the group; wherein the transmitting interface is further configured to transmit a digital representation of the purchased at least one merchant credit vouchers to the mobile client terminal for payment by the user at the merchant; and a payment processing module configured for crediting an account of the user and debiting an account of a seller of the purchased at least one merchant credit voucher after the transmission of the digital representation.

Optionally, the system further comprises a user interface for installation on the mobile client terminal, the user interface configured to communicate with the central server to transmit the geographical location and the purchase order, and to receive the list and the digital representation.

Optionally, the geographical location is calculated by a geographical location module configured to calculate the geographical location with a resolution precision to differentiate the position of the user between physical stores.

Optionally, the system further comprises a pricing module configured for calculating discounted prices off a face value of the available identified at least one merchant credit vouchers for sale, the discount calculated based on at least one of estimated time period to sell and estimated market demand.

Optionally, the system further comprises a commission module for calculating a commission to be paid by each of a buyer and a seller based on the face value or the discounted value of the credit voucher.

Optionally, the system further comprises a credit voucher splitter module for dividing the credit voucher into multiple child credit vouchers, such that the sum of the face value of all child credit vouchers is equal to the face value of the credit voucher.

Optionally, the system further comprises a merchant interface for communicating with the at least one merchant stored in a database of multiple merchants, the merchant interface requesting re-issuance of a new identification of the credit voucher after sale, and assignment of cancellation status to the pre-sale credit voucher. Optionally, the new identification is issued to a digital representation of a paper or plastic based credit voucher, and the cancellation status is assigned to the paper or plastic based credit voucher. Optionally, the re-issuance is configured to prevent fraud due to double-usage of the credit voucher.

Optionally, the system further comprises a credit voucher combination module for combining face values of multiple credit vouchers each received from different respective sellers, into a single credit voucher having a combined face value for sale to a single buyer.

Optionally, the credit voucher database stores digital representations of paper or plastic based credit vouchers issued to respective sellers.

Optionally, the system further comprises uploading the digital representation to the central server from the mobile client terminal, and storing the digital representation in the credit voucher database.

Optionally, the mobile client terminal is configured to perform the payment by the user at the merchant with the digital representation of the credit voucher based on one or both of an electronic and a visual signal transfer with a computer of the merchant.

Optionally, the mobile client terminal includes the credit voucher module configured for matching at the mobile client terminal.

Optionally, the payment processing module is further configured to debiting an account of a seller is a period of time after crediting an account of the user, and after verifying proper receipt of the voucher by the seller.

Optionally, the payment processing module is further configured to allow users to exchange vouchers with each other.

Optionally, the payment processing module is further configured to: provide to a certain redeeming merchant information regarding which users possess vouchers for the respective redeeming merchants, the user possessed vouchers denoting a debt of the certain redeeming merchant; receive from the redeeming merchant a clearance fee; and clear or reduce the debt by using the clearance fee to purchase the user possessed vouchers.

Optionally, the payment processing module is further configured to pay the seller in virtual points. Optionally, the payment processing module is further configured to allow the seller to pay with the virtual points when purchasing vouchers from other sellers, or to exchange the virtual points for real currency.

Optionally, the system further comprises a pricing module configured to dynamically adjust the sale price of the voucher so that the sale price is automatically incrementally reduced as the expiration date nears.

Optionally, the system further comprises a pricing module configured to select a price for friends based on social connections of the user based on an analysis of one or more social networks the user has joined, the price for friends selected to be lower than an estimated market price for the voucher being sold. Optionally, the same voucher being sold is presented with the price for friends to mobile devices of social connections of the user and presented with the estimated market price to mobile devices of other potential buyers.

Optionally, the system further comprises an automated buyer agent module configured to automatically purchase at least one voucher based on user selected predefined set of rules.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method for location based buying of credit vouchers, in accordance with some embodiments of the present invention;

FIG. 2 is a flowchart of a method of selling credit vouchers based on location, in accordance with some embodiments of the present invention;

FIG. 3 is a block diagram of an exemplary system for location based buying and/or selling of credit vouchers, in accordance with some embodiments of the present invention; and

FIGS. 4A-4C are screen capture images of an exemplary implementation of a user interface, in accordance with some embodiments of the present invention.

### DETAILED DESCRIPTION

The present invention, in some embodiments thereof, relates to methods and systems for merchant credit voucher transactions and, more specifically, but not exclusively, to methods and systems for location based merchant credit voucher transactions.

As used herein, the phrase merchant credit voucher or credit voucher or voucher means a voucher having certain monetary value that may be used for purchases at a certain merchant, such as the merchant that issued the voucher. Exemplary vouchers include, a giftcard, a store credit based on a returned store item, and a merchant issued coupon. As described in more detail below, the credit voucher may be a physical voucher, for example, a paper-based voucher or a plastic-based voucher, and/or a digital representation, for example, a scanned and/or photographed version of the physical voucher, and/or a digital record.

It is noted that store credits based on returned store items are different than gift cards. Store credit is a method widely used by retailers that allows consumers to replace or exchange products under specific terms and limitations. Due to store policy, people who exchange or return products to a retailer may not receive cash, but instead they may receive a store credit. Consumers are often stuck with store credit notes that they have no use for, ultimately throwing them away, forgetting about the credit, losing the credit, or buying something they don't really need. In the United States and Canada, many stores offer customers cash (or debiting of credit cards) when items are returned. In the rest of the world, many stores provide a store credit for the value of the returned amount that is only remediable at the issuing merchant. The store credits may have different values than gift cards, which are provided as gifts. For example, store credits may have wider ranges of values depending on the purchased item(s), for example, less than about $1, or less than about $5, or less than about $10, or less than about $20, or more than about $100, or more than about $500, or more than about $1000, or more than about $2000, or other amounts, while gift cards have a more limited range based on average gift prices, for example, about $25-$50. The store credits may have associated expiration dates for redemption, while the gift cards may not have such expiration dates. The store credits may require redemption of their full value in a single transaction, with any partial amounts being lost. The value of gift cards may be partially redeemed each time during multiple transactions. Gift cards are for purchases of a gift, and so the recipient does not necessarily want cash, but instead wants to purchase an item of interest for their gift. Store credits are generally undesirable to the consumer, as the consumer that returned the item does not necessarily want to purchase something else. As such, methods and/or systems designed for gift card exchanges may be unsuitable for buying and/or selling of store credit for money.

An aspect of some embodiments of the present invention relates to methods and/or system for purchases of merchant credit vouchers based on the geographical location of the user, for example, during a shopping trip of the user. Based on the geographical location of the user, credit voucher(s) available for sale and redemption in merchants within shopping proximity to the user are presented to the user for purchase. The systems and/or methods allow the use to purchase the credit voucher(s) and redeem the credit voucher (i.e., by purchasing an item at the physical store of the merchant) optionally during the same shopping trip, for example, purchase the voucher and redeem the voucher while remaining inside the store. In this manner, the systems and/or methods provide the unexpected property that the purchase of the voucher may be made substantially immediately before redemption and/or during the shopping trip, for example, when the user is inside a shopping complex before entering the store, while the user is inside the store browsing for items, while the user is waiting in line to pay for an item, while the user is in another store, while the user is walking towards the store, and/or while the user is taking a break and eating in the food court of the shopping complex. The user does not need to plan the purchase of the voucher in advance (for example, days in advance), before setting out on the shopping trip.

The credit voucher(s) are offered for sale at a discounted price to the face-value. The user may purchase and redeem the discounted voucher during the shopping trip, saving money, for example, on an item that they would have purchased anyway. As the credit voucher is considered like cash by the merchant, the user may enjoy double discounts, for example, using the discounted purchased credit voucher to buy items on sale.

Optionally, the user engaging in a shopping trip is automatically detected based on the geographical location of the user. For example, the user entering a shopping complex and/or the parking lot of the shopping complex is automatically detected. As used herein, the term shopping complex means, for example, an indoor shopping mall, an outdoor shopping mall, a street having multiple stores, and/or a building having offices and/or stores therein. Shopping complexes may have a concentration of merchant stores. Exemplary merchant stores include: walk-in stores, kiosks, stores selling physical products, offices, and/or service providers.

Optionally, vouchers redeemable at stores within shopping proximity are automatically identified and presented to the user located within the shopping complex. As used herein, the term shopping proximity means merchant stores located within the shopping complex itself, or within short walking distance, such as a distance of less than about 20 meters, or less than about 50 meters, or less than about 100 meters, or less than about 250 meters, or less than about 500 meters, or other smaller, intermediate or larger distances.

Optionally, the movement and/or geographical position of the user is automatically analyzed to determine the closest merchant store(s) to the user having redeemable credit voucher(s) for sale. Optionally, the closest store is the store the user is located within. Alternatively or additionally, the closest store(s) is the store the user is standing in front of, and/or next to. Alternatively or additionally, the movement of the user is analyzed to determine an orientation vector along the walking path of the user, to a merchant store. The credit voucher(s) of the closest store(s) and/or the store(s) the user is walking towards are provided to the user as options for purchase.

Optionally, the geographical location of the seller of the voucher is analyzed. When the seller and user (i.e., buyer) are both located in near proximity to one another, for example, within the same shopping complex, a meeting may be arranged between the buyer and seller for physical transfer of the voucher (for example, purchase of the paper based voucher). The user may obtain the voucher directly from the seller right before making purchases in the same shopping complex.

Optionally, the location of the user during the shopping trip is tracked and analyzed. Different vouchers available at different nearby stores within the shopping complex may be presented to the user, for example, as the user walks through a mall, different vouchers for merchant stores at different locations in the mall may be presented. In this manner, the volume of available vouchers may be reduced, as instead of all the stores in the shopping complex having vouchers being presented, vouchers for stores in the direct vicinity of the user are presented, for example, stores on the same floor as the user, and/or stores in the same wing as the user. As used herein, the term nearby sometimes means stores within a very short walking distance, for example, less than about 10 meters, or about 20 meters, or about 50 meters, or other smaller, intermediate or larger values.

As used herein, the terms nearby, shopping proximity, geographical redemption area, and geographical redeeming area are sometimes interchangeable.

Optionally, the user purchases the voucher with money, for example, using a credit card, debit card, direct money transfer, and/or third party money transfer intermediary. The user does not necessarily need to trade a different voucher for the desired voucher. Any desired voucher may be purchased for money.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

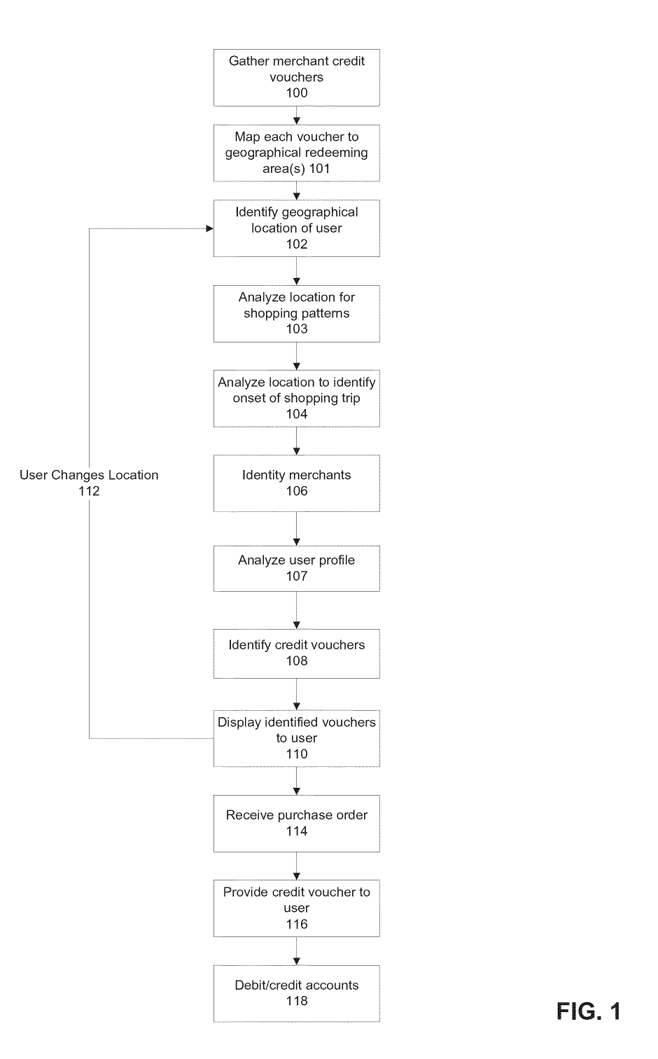

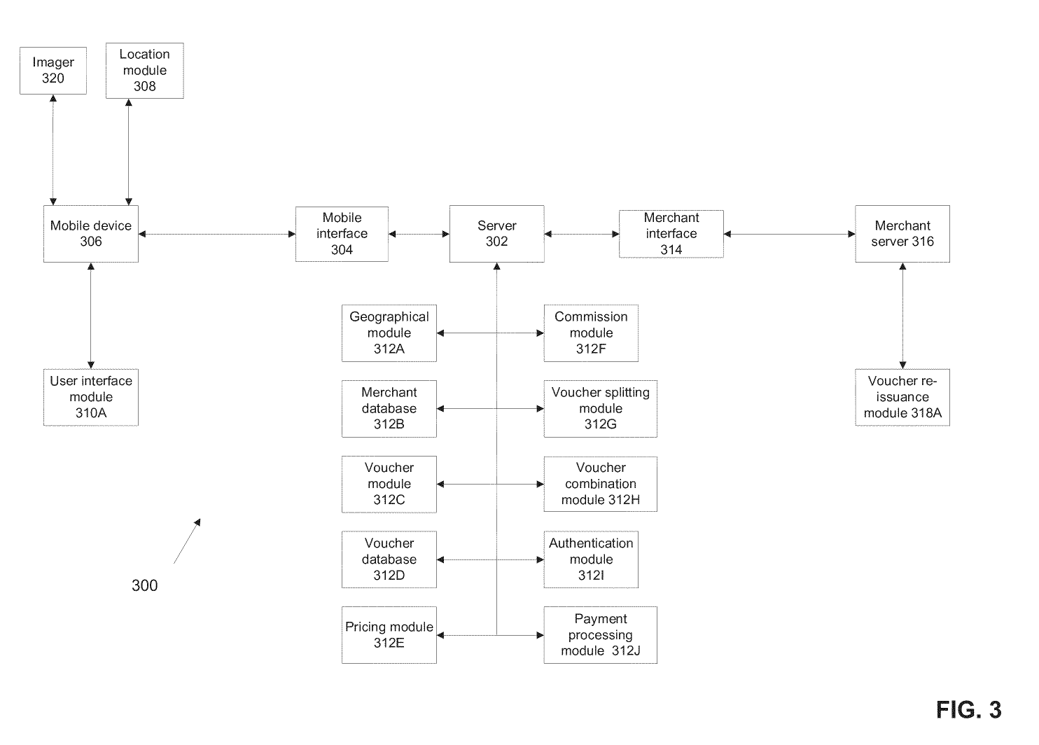

Reference is now made to FIG. 1, which is a flowchart of a method for purchasing credit vouchers based on location of the user during a shopping trip of the user, so that the purchased voucher is used to pay for an item purchased during the shopping trip, in accordance with some embodiments of the present invention. The method of FIG. 1 allows the user to purchase a discounted credit voucher and substantially immediately redeem the voucher during payment for an item, effectively buying the item at a discounted price to the merchant's requesting price. FIG. 1 represents the method from the viewpoint of the credit voucher purchaser. Reference is also made to FIG. 3, which is a system 300 for selling and/or purchasing credit vouchers based on user location, in accordance with some embodiments of the present invention. System 300 may execute the method of FIG. 1.

The systems and/or methods provide potential benefits to both the consumers and the merchants. The consumers may benefit from ability to sell vouchers for cash and/or buy vouchers at a discount for many different merchants. The merchants may enjoy consumers that purchase at higher transaction values than the voucher value, and/or may return for further purchases.

The systems and/or methods may provide for a paper/plastic free experience, as once a digital representation of the paper or plastic based voucher has been made, the original may be discarded. Alternatively, the original physical voucher is traded.

The systems and/or methods allow cash redemption of vouchers, before the vouchers become lost, stolen, or forgotten about, before the voucher is redeemed at the merchant.

The systems and/or methods may allow for buying and/or selling of vouchers without necessarily requiring face to face meetings between the buyer and seller to change possession of the physical credit voucher. When users prefer such face to face meetings, the systems and/or methods facilitate the meeting by determining when the buyer and seller are close to one another.

The systems and/or methods may reduce the risk of buying and/or selling of physical vouchers directly between individuals, by providing a platform that authenticates the validity of the vouchers and guarantees the financial transaction. Direct buying and selling may lead to fraud, for example, preventing or reducing transactions with previously used vouchers, forgeries, and/or expired vouchers.

The systems and/or methods allow merchants to participate in the buying and/or selling process of vouchers, as will be described in more detail below. Merchants participating in the system and/or methods may enjoy higher sales, as customers may spend more in their store than the value of the voucher, merchants may get new customers using the vouchers, merchants may provide a way for customers to convert item refunded store credit into cash which may avoid negative feelings by the customer towards the merchant, and/or merchants may promote themselves using the vouchers. A central server may communicate with one or more servers of the merchants, and/or merchants may provide information for direct processing by the central server.

The systems and/or methods described herein may improve performance of a computer, for example, server 302 and/or mobile device 306. The computer may perform more efficiently and/or in an optimized manner, which may required fewer resources and/or the computer may perform more quickly using the existing resources. The improvement in performance may be based on selection of the vouchers that are most relevant to each user out of a large list of all available vouchers, instead of presenting all available vouchers to each user, as described herein.

System 300 includes a central server(s) 302, having or connected to a hardware processor(s) and a memory storing one or more databases and/or modules for instruction execution by the processor as described herein.

Central server 302 includes or is connected to one or more mobile interfaces 304 for communication (transmit and/or receive) with multiple remote client terminals, such as mobile devices of users. Mobile devices 306 may include, for example, a Smartphone, a Tablet computer, and/or a laptop computer. Mobile devices 306 communicate with server 302 through wired and/or wireless connections, for example, through a cellular network and/or internet connection.

Optionally, mobile device 306 is configured for generating a signal denoting a geographical location of the user, for example, mobile device 306 includes a geographical location module 308, for example, a global positioning system (GPS) module. Alternatively or additionally, location module 308 is a separate device from mobile device 306, for example, worn by the user. Alternatively or additionally, the position of mobile user and/or mobile device 306 is identified based on triangulation between cellular towers providing service to mobile device 306.

Geographical location module 308 may be configured to calculate the geographical location of the user with a resolution precision to differentiate the position of the user between physical stores.

Mobile device 306 may have stored thereon a user interface module 310A for providing control access to the user, for example, to display available credit vouchers, sell a voucher, buy a voucher, make payments, and other actions as described herein. User interface 310A may be a mobile software application optionally downloaded from server 302. User interface 310A may be programmed to run on an operating system of mobile device 306, for example, Android®, and/or iOS®. Alternatively or additionally, user access is provided by server 302 acting as a web-server hosting a website that provides the actions. Server 302 may integrate web-based transactions together with mobile device based transactions into a single platform to allow transactions between the different users.

It is noted that one or more of the vouchers described herein (i.e., 312A-J) may reside at server 302, at mobile device 306, or on both server 302 and mobile device 306, to perform functions at server 302 and/or at mobile device 306. For example, voucher module 312C may perform the voucher matching at server 302 and/or at mobile device 306.

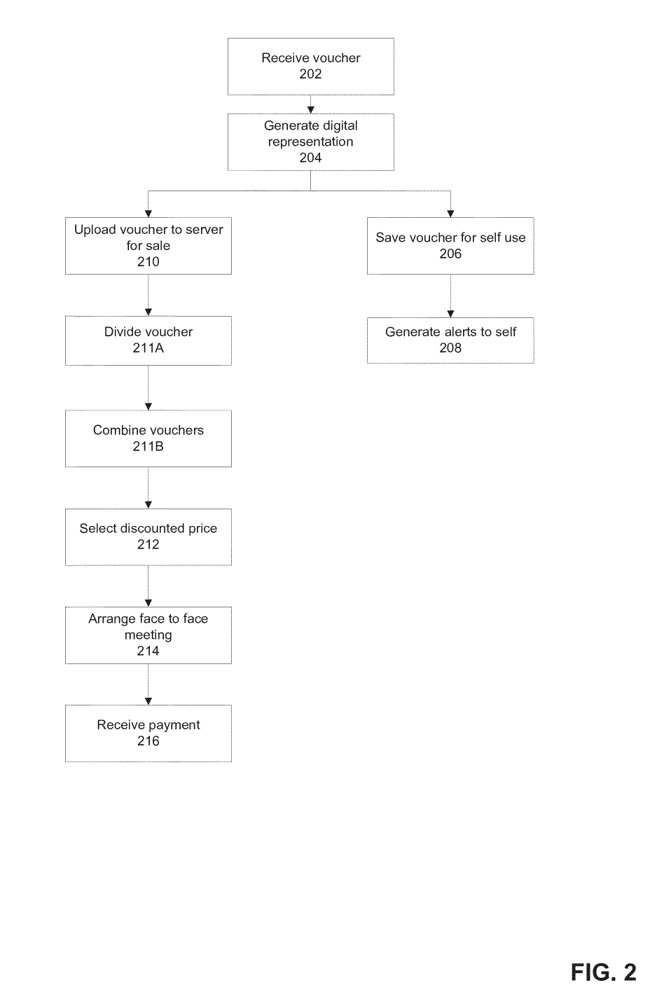

At 100, multiple merchant credit vouchers are gathered from users looking to sell their vouchers. The merchant credit vouchers may be uploaded by the users using their mobile devices 306 to central server 302, and stored in voucher database 312D. Additional details of users providing their vouchers for sale are described with reference to FIG. 2.

At 101, each respective received merchant credit voucher is mapped to at least one geographical redeeming area. In this manner, each respective geographical redeeming area contains one or more related vouchers that may be redeemed at merchants located within the geographical redeeming area. The geographical redeeming areas may be organized, for example, based on latitude and/or longitude cells (for example, divided by squares having a predefined absolute area), based on streets (for example, bounded by certain streets), and based on shopping complexes (for example, by mall, shopping district). The same voucher may be mapped to more than one geographical redeeming area, for example, to a mall, and to a geographical zone of a predefined size containing the store. The geographical redemption area may be based on the size of the shopping proximity area described herein.

The mapped vouchers may be stored in database 312D.

At 102, the geographical location of the user is identified. Optionally, the geographical location of the user is received at server 302 from mobile device 306. The geographical location may be transmitted to server 302 when user interface 310A is not active.

Optionally, the geographical location of the user includes a navigated to location, where the user is expected to arrive. For example, the geographical location is a shopping complex in a different city than where the user lives. The user has entered the geographical location of the shopping complex in a navigation application for directions (i.e., walking, driving, and/or public transportation) to the geographical location. Vouchers may be selected and/or presented to the user that correspond to the end target geographical location, along the navigation route presented by the navigation application, and/or in the near vicinity as the user is travelling. The system and/or method described herein may be integrated with the navigation application, to display available vouchers along the navigation route and/or at the end target destination. For example, the navigation module installed on mobile device 306 of the user transmits one or more of the current location of the user, the proposed navigation route, and the target destination to server 302. Server 302 processes the received navigation related data as described herein with reference to the geographical location.

Optionally, the geographical location of the user is matched to one or more of the geographical redeeming areas, for example, by geographical module 312A.

Optionally, at 103, the user location is analyzed to identify shopping patterns. The user location may be tracked to identify shopping complexes visited on a regular basis, for example, part of a weekly shopping trip. The method may perform the described processing to present the user with available vouchers for the shopping complex(s) the user is expected to visit. The user may be presented with the list while outside the shopping complex, independently of location, for example, once a day, twice a day, or once a week. For example, the system may determine that the user is married, the user's spouse has a birthday coming up soon, and that the spouse likes a certain clothing store chain. Based on the user profile, the system may present vouchers for redemption at the clothing store chain branch at the shopping complex the user usually visits on a weekly basis. The voucher may be presented before the user is expected to arrive at the shopping complex (for example, the night before) and/or while the user is at the shopping complex.

Optionally, at 104, the geographical location is analyzed to identify the onset of a shopping trip by the user. When the onset of the shopping trip is determined, the method proceeds further to subsequent blocks described below. When the shopping trip has not yet started, the method may wait until the shopping trip has started, or provide credit vouchers based on predefined rules instead of current geographical location, for example, based on predefine periods in time, and/or based on vouchers to merchants having products satisfying a user preference shopping profile, for example, as described with reference to block 103. Alternatively, the geographical location is analyzed to verify that the user is still participating in the shopping trip.

The shopping trip may be detected, for example, by the user arriving at the shopping complex, travelling towards the shopping complex, and/or arriving at the parking lot of the shopping complex.

Optionally, at 106, merchants having physical stores nearby and/or in shopping proximity to the user are identified based on the geographical location of the user during the shopping trip. Optionally, merchant stores within the entire shopping complex, a part of the shopping complex near the user, and/or outside the shopping complex in shopping proximity to the user are identified. The distance to the furthest store (i.e., the shopping proximity distance and/or the near distance) may be preselected by the user and/or preset by the system.

Alternatively or additionally, the merchants are identified based on a preference shopping profile of the user. Merchants having items for sale which are determined to be of interest to the user based on the profile are identified. The merchants may have stores nearby and/or in shopping proximity to the user.

Alternatively or additionally, merchants that are competitors of the store the user is visiting and/or are located nearby to the visiting store are identified. The competitor merchants may be located in shopping proximity and/or nearby to the user, for example, within the same shopping complex as the user is located, or nearby to the shopping complex.

The geographical matching analysis may be performed, for example, at central server 302 by a geographical module 312A, at the mobile device 306, and/or at another server. The geographical matching may be performed by accessing a merchant database 312B of multiple merchants where each respective merchant is associated with one or more geographical locations. Database 312B may store competition data, associating one or more merchants with competitors nearby and/or within shopping proximity.

Optionally, at 107, the user location is matched to identify merchants and/or available credit vouchers (in shopping proximity to the user) based on an analysis of the user shopping interest profile, for example, by voucher module 312C or other analysis modules. The user profile based matching may be used to reduce the list of available vouchers to a sub-set of vouchers redeemable at merchant stores having items and/or services that may be of interest to the user based on the shopping profile. The shopping profile may include one or more of the following exemplary parameters: user defined preferences, previous shopping history, gender, age, demographics, geographical location, previous voucher purchase history, previous usage patterns, browsed websites, web search history, web purchase history, and/or other suitable parameters. The user profile may include an analysis of one or more social networks the user has joined (for example, a Facebook® page of the use), for example, the items the user has marked as like, the items the user has shared, items the user has taken an action on, items the user has interacted with, friends that the user interacts with more or less, item preferences of social network friends of the user, and other parameters available from the social network profile of the user, for example, age of the user, location where the user lives, marital status of the user, birthday, and other extractable parameters.

The user profile may be detailed, including multiple parameters (which the user may provide or allow the system to automatically detect), or the profile may be sparse based on a generic user profile based on limited information available from the use, for example, age and/or gender of the user. In this manner, the market of available vouchers is personalized to the respective user, for example, a 20 year old male and a 60 year old female standing in the same location within a shopping complex may receive different available vouchers for sale based on their respective user profiles. The user may adjust their own user profile (for example, through the user interface) in order to customize the voucher market feed. The vouchers may be processed based on the profile before being displayed to the user, for example: selectively filtering out vouchers that do not fit the constraints of the user profile, sorting the available vouchers by a ranking of more relevant vouchers based on the user profile, bolding or highlighting the user profile related vouchers out of all available vouchers.

Alternatively or additionally, at 108, credit vouchers for redemption at the identified merchants nearby and/or in shopping proximity to the user, are identified.

Optionally, a group of merchant credit vouchers redeemable with merchants located within the geographical redemption area of the user are identified. The group may be identified by matching the geographical redemption area of the user with the vouchers based on voucher database 312D.

The credit vouchers may be identified for competitors of the store the user is located within, or nearby to. The user may buy the same or similar item at a store of the competitor at a cheaper price by purchasing the credit voucher for redemption at the store of the competitor.

The merchant credit voucher analysis may be performed, for example, at central server 302 by a credit voucher module 312C, based on accessing a credit voucher database 312D storing credit vouchers offered for sale by respective merchants. Database 312D may store digital representations (for example, scanned and/or digitally photographed versions) of paper based credit vouchers issued to respective sellers.

It is noted that blocks 106 and 108 may be combined together. Merchant database 312B and voucher database 312D may be combined together. Geographical module 312A and credit voucher module 312C may be combined together. When combined, the geographical location of the user may be directly matched to the vouchers redeemable at merchants within shopping proximity and/or nearby. The combined database may store the available vouchers for sale associated with one or more geographical locations and optionally with the redeeming merchant. The user profile may be analyzed for matches with available vouchers.

At 110, the identified available credit voucher group is provided for display to the user. The identified credit vouchers may be provided as a location based alert. The credit vouchers may be transmitted (optionally as a list) from server 302 to mobile device 306, and optionally displayed on the screen of device 306 by user interface 310A.

Optionally, the available credit vouchers are transmitted to mobile device 306 without user interface 310A being necessarily active. For example, based on a push notification application, a short message service (SMS) text message, an email, and/or a phone call. The user receives the list during the shopping trip, even when user interface 310A is not active.

The list of available identified merchant credit vouchers may be transmitted to the user as the user is located within the shopping complex. The list includes at least some credit vouchers redeemable at merchants located within the shopping complex.

Optionally, at 112, the user has changed locations, for example, by walking within the shopping complex, or moving to a different shopping complex. The change in location may be significant enough to trigger re-analysis of the geographical location for generation of a new set of available vouchers as described herein in reference to blocks 102, 103, 104, 106, 107, 108 and/or 110.

Alternatively or additionally, at 114, the user issues a purchase order to purchase one or more of the available credit vouchers. The purchase order may be received at the central server 302 from mobile device 306, for example, through user interface 310A.

Payment may be processed by a payment processing module 312J, which may accept direct payments (for example, credit card) and/or conduct transactions through a third party. In this manner, the risk of non-payment is reduced to the user and taken on by the operator.

At 116, the purchased credit voucher(s) is provided to the user. A digital representation of the credit voucher may be transmitted from central server 302 to mobile device 306, for example, a scanned copy of the voucher, a newly issued electronic version of the voucher, and/or an electronic record of the voucher. The user may use the digital representation of the voucher for payment at the merchant.

Alternatively, for example, based on user preference, a physical voucher is provided to the purchasing user. The voucher may be the same voucher sold by the seller or a reissue thereof. In such a case, the system may arrange for physical delivery of the voucher to the user, for example, by mail or messenger. The operator of the system may secure the transaction in case of lost or stolen physical vouchers.

The voucher may be purchased and the digital representation may be received as the user is located within a physical store of the redeeming merchant or directly in front of the entrance to the store of the merchant, before paying for items using the purchased merchant credit voucher at the store, as part of the same shopping trip.

The user may use the purchased voucher to purchase items at the redeeming merchant. One or more suitable methods may be used to pay with the digital representation of the voucher, for example, a printed physical version of the voucher, providing a code associated with the voucher to the merchant, showing the merchant the digital representation of the voucher displayed on the screen of the mobile device, displaying the voucher on the screen of the mobile device and having the merchant scan a barcode or QR code from the screen, by a connecting to a merchant system (for example, server 316) using the mobile device and performing an electronic transaction with the digital representation of the voucher, and/or by connecting with the mobile device to a third party that handles voucher transactions on behalf of the merchant. The user may pay using a code associated with the voucher (the physical or digital representation of the voucher), and not necessarily with the voucher itself, for example, using a sequence of numbers, letters and/or symbols associated with the voucher. The user may provide the code, for example, verbally to the merchant (for example, in person or over the phone), by allowing the merchant to see the code and type it into a computer (for example, the code is displayed on the screen), and/or the mobile phone may read the code out by an automated text-to-speech module. Other exemplary methods of the user paying the merchant include sending the code and/or voucher by SMS, email, or other message services, to the merchant's computer at the cash register, the merchant's server, and/or the third party intermediary. In yet another exemplary method, the mobile device may convert the voucher and/or code into audio signals (at audible frequencies or inaudible frequencies) that may be received by a microphone at the cash register and decoded by the merchant's computer. Other suitable methods of electronic, visual and/or audio signal transfer may be used between the user and the merchant to pay. User interface 310A and/or mobile device 316 may be configured to perform an electronic, visual and/or audio signal transfer with the merchant (for example, to merchant server 316, server 302, a computer located at the point of sale within the merchant's store, a third party intermediary, or other computers) to pay for user selected items with the digital representation of the voucher (and/or the physical voucher).

Optionally, the credit voucher provided to the user is a re-issue of the purchased credit voucher and/or a re-issue of the credit voucher provided by the seller for sale. The new credit voucher may contain a new assigned identification, for example, a new identification number. The previous credit voucher may be reassigned to have a cancelled status. The new identification may be issued to a digital representation of a paper-based credit voucher, and the cancellation status may be assigned (for example, electronically in a database of the merchant) to the paper-based credit voucher. Alternatively, a new paper or plastic based voucher may be reissued. In this manner, fraud due to double-usage of the credit voucher may be prevented or reduced.

The re-issue may be requested by server 302 through a merchant interface 314 communicating with respective merchant servers 316. Merchant server 316 may cancel the old credit voucher of the seller and issue a new credit voucher to the buyer, for example, by a re-issuance module 318A. The seller may be advised (for example, by an automated message) that the old voucher has been cancelled.

The re-issuance and/or cancellation may help to reduce or prevent fraud. For example, during a transaction, both seller and buyer are in possession of the voucher at some point, and/or both are aware of the identification number of the voucher. After the sale, the seller may attempt to redeem the already sold digital representation of the voucher before the purchaser is able to redeem the same voucher. Alternatively, the seller may forge a copy of the sold voucher. The merchant may not be able to identify the real owner, and may have to honor the first redeemed voucher.

Optionally, at 118, financial accounts of the buyer and seller are settled, after the transaction has been completed by transferring ownership of the credit voucher to the buyer. An account of the buyer is credited, and an account of a seller is credited. Payment may proceed by suitable methods, for example, by credit card, debit card, direct transfers using bank accounts, third party settlement, or other methods. The financial settlement may be automatically controlled by payment processing module 312J.

Optionally, the account of a seller is debited a period of time after crediting an account of the user. The delay in transferring money to the seller may allow for verifying proper receipt of the voucher by the seller, which may help ensure that fraud was not committed by the seller. The money being held in the interim period by the system, between being received by the buyer and transferred to the seller may be temporarily deposited with a financial institution to earn interest.

Optionally, commission for payment to the operator of the method and/or system is calculated and/or paid. Optionally, server 302 has stored thereon or is connected to a commission module 312F for calculating a commission to be paid by the buyer and/or seller to the operator of server 302. The commission may be calculated based on the face value of the credit voucher. The commission may be calculated after the transaction has completed, automatically obtained as part of the financial transaction (for example, built in to the price of the voucher), or paid in advance.

Commission may be charged to both the buyer and the seller, for example, 2.5% to each.

Alternatively, no commission is charged. Users may buy and sell without paying additional fees or commissions. In such a case, fees (for example, commission, membership fee, and/or per transaction fee) may be charged only to users identified as heavy users (i.e., large number of transactions above a threshold), merchants and/or commercial users (for example, investors). Light and/or personal users may use the system for free.

Reference is now made to FIG. 2, which is a flowchart of a method of selling credit vouchers based on location, in accordance with some embodiments of the present invention. The method of FIG. 2 may interact with the method of FIG. 1, in the sense that the method of FIG. 2 represents the perspective of the seller of the credit voucher, which is then bought by the buyer based on FIG. 1. The method of FIG. 2 may be executed by system 300 of FIG. 3.

As used herein, the term seller is sometimes used interchangeably with the term user (which may be the buyer), as the seller may also act as a buyer in purchasing vouchers.

Optionally, at 202, the seller receives a credit voucher, for example, after returning an item to the merchant, and/or as a gift. The credit voucher may be paper-based, plastic based, and/or represented digitally.

Alternatively, the seller is the redeeming merchant. Merchants may utilize the methods and/or systems described herein as a platform for issuing, distributing and/or selling virtual coupons, or other merchant initiated store credits. Such virtual coupons may be sold as a form of store promotion, for example, $100 for use in the merchant store may be sold at a discounted rate of $90. Merchants may allow purchasers to use the coupons to obtain additional discounts on sale items. For example, an $80 item selling for $50 may be purchased by a $50 voucher bought for $45.

Optionally, at 204, a digital representation of the paper-based credit voucher is generated, for example, using an imager 320 part of, or connected to mobile device 306, for example, a camera and/or a scanner. The digital representation may be manually performed by the seller, for example, while still located in the store after receiving the credit voucher from the merchant.

Details of the credit voucher may be manually entered by the user, and/or automatically extracted from the digital representation, for example, based on optical character recognition software optionally provided with user interface 310A. Exemplary extracted details include: redeeming merchant, expiration data, monetary face value (i.e., the value shown on the voucher, not necessarily the sale price, which is referred to as the discounted value), tracking number, and terms of use. In this manner, the user does not have to enter additional details.

Optionally, the extracted details are further processed. The expiration date may be stored and displayed along with the voucher being sold. Vouchers for sale may be priced based on the expiration date, for example, vouchers with very close expiration dates being sold at a higher discount than vouchers with expiration dates further out.

Optionally, at 206, the digital representation is stored for self-use by the user, for example, stored on a memory within mobile device 306, such as within a digital wallet. The expiration date of the voucher may be identified and stored, for example, automatically identified by optical character recognition or manually entered by the user.

Optionally, at 208, alerts are generated to the user as reminders to redeem the credit voucher. The credit voucher may be stored on mobile device 306, within voucher database 312D, or in another database and/or memory. The stored credit voucher may be displayed to the user based on geographical location, as described with reference to FIG. 1. The credit voucher of the user may be displayed alone, or along with other vouchers available for sale at the same store or in nearby stores as described with reference to FIG. 1.

Alerts may be generated based on the expiration date, to remind the user to redeem the credit voucher before expiration.

Alerts may be generated when the user is identified to be located at a competitor's store to the redeeming merchant, as a reminder that the user may leave the competitor's store and enter the redeeming merchant store to redeem the voucher.

Alerts may be generated when the user is identified to be located in shopping proximity to the redeeming merchant of the voucher owned by the user.

Alternatively, at 210, the digital representation of the voucher is offered for sale. The digital representation may be uploaded to server 302 from mobile device 306, and optionally stored in credit voucher database 312D. The upload may be performed quickly, for example, in less than about 10 seconds. The voucher may be offered for sale to potential buyers as described with reference to FIG. 1.

Optionally, the uploaded voucher is authenticated, to verify that the voucher is not a fake, has not been previously redeemed, and/or has not yet expired. Authentication may be performed by an authentication module 312I that issues an authentication request to the respective merchant server 316, and/or performs a validation check based on parameters extracted from the digital representation of the voucher.

Optionally, at 211A, the credit voucher of the seller may be divided up into multiple child credit vouchers, where the sum of the face value of all child credit vouchers is equal to the face value of the original credit voucher. Each child credit voucher may be sold to a different buyer. Each child may have a different face-value.

Splitting of the credit voucher may be performed, for example, by a credit voucher splitting module 312G stored on server 302, which may request from the respective associated merchant 316 to re-issue the credit voucher as multiple child vouchers. The original parent voucher may be cancelled.

The credit voucher may be split, when the face value of the credit voucher is high, for example, above a predefined threshold that is based, for example, on the demand for credit vouchers according to face value. High valued vouchers may take longer to sell, and/or may require larger discounts for a buyer to purchase them. High valued vouchers may have a smaller market, as consumers typically may not spend large sums in a single transaction and/or at a single store. The high valued voucher may require redemption in a single transaction by the redeeming merchant. Multiple vouchers with lower and/or moderate values obtained from a split high value voucher may each sell quicker than the parent and/or be sold with a lower relative discount than the parent.

The split vouchers may be sold at the same relative discount as the parent, for a higher relative discount (for example, to sell them faster than the parent), or for a lower relative discount (for example, to reduce total financial reductions).

Exemplary values of high valued vouchers include: above about $100, or above about $250, or above about $500, or above about $1000, or other values. Exemplary values of moderate or lower priced vouchers which may be assigned to child vouchers include: about $20-$100, or about $50-$100, or about $50-$200.

Splitting may be initiated at the request of the redeeming merchant. The multiple vouchers may be bought by multiple different people, who become potential regular clients of the merchant. The purchasers of the child vouchers may overall spend more than the total value of the vouchers, as each person making individual purchase may use the voucher to purchase an item with a higher value than the child voucher. Unhappy clients that returned high value items to the merchant may be offered a solution to salvage value from the issued store credit.

An investor (which may be the operator of the system or other entities) may select to purchase a high valued voucher at a deep discount, and split the voucher into multiple child vouchers each being sold at a lower discounted rate such that overall a profit may be made based on the split.

Optionally, at 211B, multiple credit vouchers received from different sellers, and/or from the same seller, are combined into a single credit voucher for sale to a single buyer. The multiple credit vouchers may be donated by respective sellers (with proceeds from the sale going to a charity instead of to the respective seller). The multiple credit vouchers may be pre-purchased by the operator of server 302 from each seller, combined, and then sold to the single buyer. Credit vouchers of amounts that are small to sell individually (for example, about $1, or about $5, or about $10) may be combined into a voucher having an amount that is expected to be sold relatively easily (for example, about $50, or about $100, or about $250, or greater).

Vouchers may be combined, for example by a credit voucher combination module 312H stored on server 302, which may request from the respective associated merchant 316 to re-issue a single credit voucher having the combined value of the multiple vouchers. The original multiple vouchers may be cancelled.

Optionally, at 212, the sale price of the voucher is selected. The sale price may be selected to be at a discount off the face-value of the voucher. The face value, and/or the discounted price and/or the discounted percent may be presented to the potential buyer, which may help the buyer compare discounts between different vouchers being offered for sale. The price may be selected manually by the seller and/or automatically by the system and/or based on a recommendation by the system, for example, by a pricing module 312E.

The price may be calculated based on an estimated desired time period to sell the voucher and/or estimated market demand. Other exemplary factors to consider include the season, and prices of other similar vouchers. For example, the lower the price, the quicker the sale is expected. In another example, the greater the demand for similar vouchers, the higher the price (or the lower the discounted voucher rate). For example, the discounted price may be matched based on a previous history of prices for other vouchers redeemable at the same merchant.

Optionally, the price is dynamically adjusted, such as by a function, for example by pricing module 312E. The price may decrease over time (for example, incrementally every preset period of time, or continuously), for example, the discounted rate may be increased as the expiration date gets closer. The dynamically adjusted price may help salvage value from the voucher before the expiration date based on market demand.

Optionally, a time limit is selected for the sale of the voucher at the preselected price. When the time limit is reached and the voucher has not been sold, the seller may be prompted (for example, through the mobile device) with the option to retrieve back the unsold voucher, or select another selling price which may be lower than the previous price to try and sell the voucher. The price may be dynamically adjusted based on a set of rules (which may include the time limit), which may be received from mobile device 306 after being selected by the user through user interface module 310A.

Optionally, a price for friends for the voucher is selected based on social connections of the user, for example, based on an analysis of one or more social networks the user has joined as described with reference to block 107 of FIG. 1. The price for friends may be lower than the average market estimated price.

The sale price of the voucher may be presented differently to different people, for example, through interface module 310A of each respective mobile device 306 of each user. Optionally, the same voucher for sale is presented to social friends of the user with the selected price for friends, and presented to other potential buyers with a higher price (which may be the estimated market value).

Exemplary discount percentages include: 5%, 10%, 15%, 20%, 25%, 30%, 33%, 40%, 50%, or other discounts may be calculated as described herein.

Pricing module 312E may help fine tune the price based on user input, and/or available market data. The automatically calculated price may be displayed to the user as a recommendation, which the user may accept or select a different price.

Investors (for example, the system operator) may purchase one or multiple vouchers at a high discount rate, and then resell the voucher(s) at a lower discount, effectively making a profit on the transaction. Optionally, an estimated market price for one or more vouchers being sold is calculated, for example, by pricing module 312E. Alternatively or additionally, the estimated market price is calculated for a voucher that has not yet been offered for sale. The market price may be estimated based on an analysis of statistical data based on the voucher market, for example, an analysis of the face value and/or discounted rates of other similar vouchers that have previously been sold. Parameters related to the purchase and/or sale are selected to make a profit for the investor, for example, the time and/or date to buy, the time and/or date to sell, the face-value, the discount purchase rate, the discounted sell rate, redeeming merchant type, redeeming merchant location, expiration date, ability to combine vouchers, and ability to split vouchers. The purchase and/or sale of vouchers may be performed based on the analysis of statistical data based on the voucher market that may help calculate the estimated market value for each voucher, for example, an analysis of the described parameters. In this manner, the analysis may identify vouchers that are selling for less than the market value, which may then be bought by the investor and sold for their estimated market value to make a profit on the transaction.

Optionally, at 214, a face to face meeting is arranged between the seller and buyer. The meeting may be arranged when the geographical location of the seller is analyzed and determined to be concurrently nearby and/or in shopping proximity to the buyer, for example, the buyer and seller are in the same shopping complex at the same time. The meeting may be arranged by automatically sending messages to both the buyer and the seller informing each other of the other's presence. During the face to face meeting, the buyer may pay the seller (for example, in cash) and/or obtain the physical version of the voucher. The location of the seller may be received and analyzed to arrange the meeting, for example, by server 302 and/or by mobile device 306 of the seller and/or by mobile device 306 of the buyer.

At 216, the seller collects payment for sale of the credit voucher. Payment may be processed through server 302 by payment processing module 312J acting as an intermediary, or passed along directly from the buyer. Payment to the seller may occur in any suitable form, for example, wire transfer into a bank account, sending a check by mail, and/or debiting a credit card account.

The seller may select payment in monetary equivalent items, for example, virtual points and/or virtual currency. Sellers may receive a higher equivalent of the virtual money. The virtual money may be used by the seller to buy vouchers from other sellers. The vouchers may be bought with virtual money. The virtual money may be exchanged for real currency. Processing of virtual money and/or virtual points may be performed by payment processing module 312J or other suitable modules.

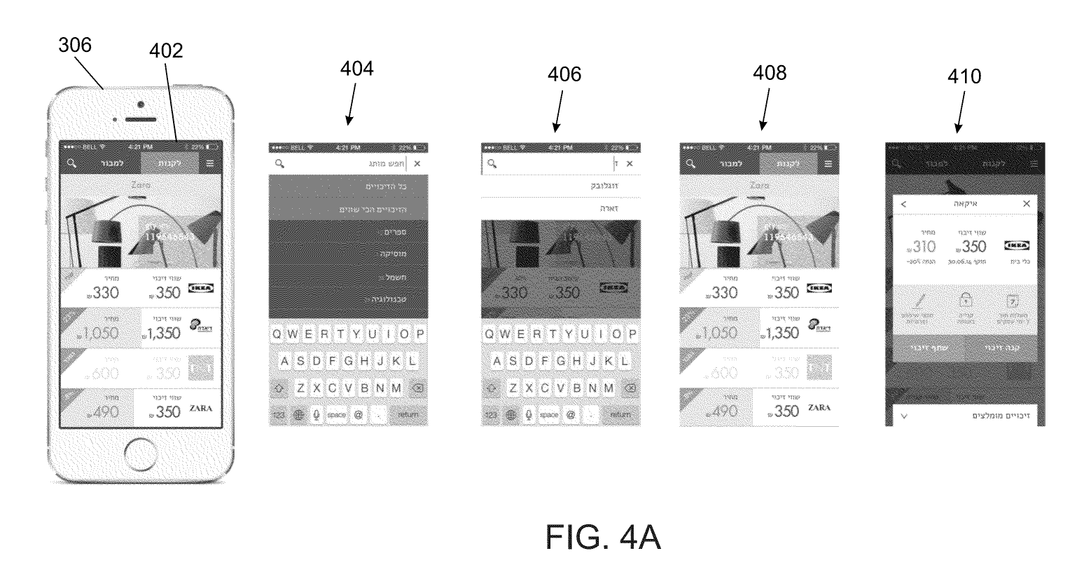

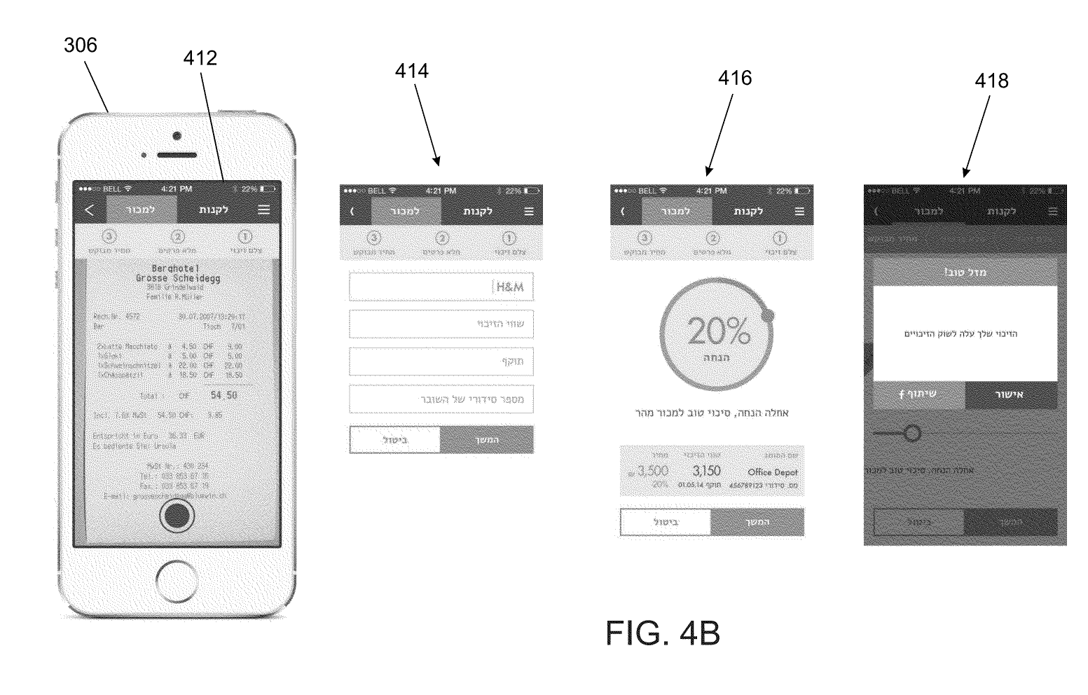

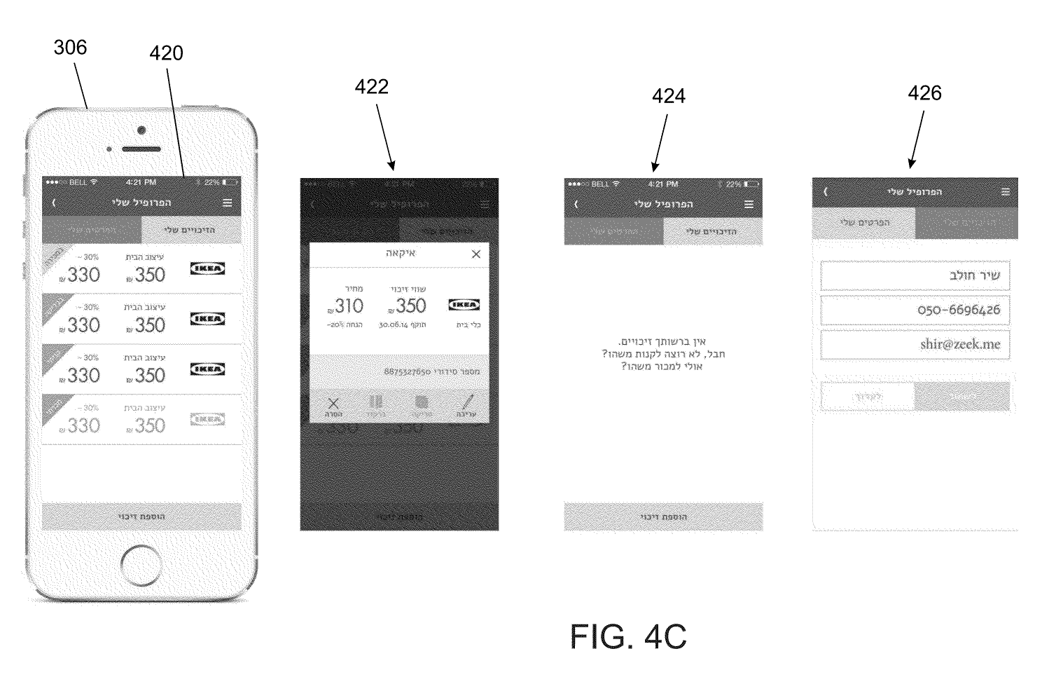

Reference is now made to FIGS. 4A-4C, which are screen captures of an exemplary implementation of user interface 310A, in accordance with some embodiments of the present invention. The user interface may be used to execute the methods of FIG. 1 and/or FIG. 2, and/or may provide additional optional features. The user interface may provide users with the ability to monitor and/or manage their vouchers. The user interface may allow the user to sort the displayed vouchers, for example, by merchant, by purchase price, by percent discount, by expiration date, and/or by geographical distance from the current location of the user.

Different users may have different user interfaces. For example, the user interface may be designed for heavy users (i.e., large number of transitions), merchants, and/or other commercial users. The commercial user interface may be designed to help the user increase profit, for example, to assist in simultaneously buying and selling large numbers of vouchers, and/or statistical analysis software to help statistically analyze their voucher portfolio and/or voucher transactions.

FIG. 4A depicts user exemplary user interface during the buying process, for example, as described with reference to FIG. 1.

Interface 402 is displayed on mobile phone 306. Alternatively, interface 402 may be displayed on other mobile devices, for example, a laptop, or a Tablet.

Interface 404 allows searching for types of vouchers, for example, based on redeeming merchant, vouchers with highest discounts, vouchers for stores selling certain items (for example, books, music, electrical appliances, technology), or all available vouchers may be displayed. The number of available vouchers in each category may be displayed.

Interface 406 allows searching for vouchers by keywords.

It is noted that vouchers may be searched from the sub-set of vouchers identified based on location, and/or may be searched without regards for location, for example, for vouchers to merchants with nationwide chains that may be redeemed at multiple locations.

Interface 408 has tabs to allow the user to buy or sell vouchers. When buying vouchers, interface 402 displays a list of available vouchers, with their face value, discounted value, and percent discount. The logo of the redeeming merchant may be displayed for quick recognition by the user. Vouchers being sold by the user may be marked (to avoid self-purchasing). Recently sold vouchers may be marked.

Interface 410 displays additional details of a specific selected voucher, for example, the category of the merchant (for example, household items), the expiration date, terms of redemption, and delivery mode (i.e., digital representation and/or mailing of the physical voucher).

FIG. 4B depicts exemplary user interfaces during the selling process, for example, as described with reference to FIG. 2.

Interface 412 depicts a scanned or photographed image of the credit voucher, optionally scanned or photographed by a camera of mobile device 306.

Interface 414 allows entering additional details related to the photographed voucher, for example, redeeming merchant, face value, expiration date, and tracking number. The details may be automatically extracted from the photographed voucher by a software module, manually entered by the user, or the user may verify and fix the automatically extracted details.

Interface 416 displays the discount of the face value of the voucher, and the absolute price at which the voucher will be sold. The price may be automatically calculated and recommended to the user by the system, or manually entered. Interface 416 may provide a summary recommendation, for example, “excellent discount, good chance for a quick sale”.

Interface 418 confirms that the details of the voucher for sale have been successfully uploaded to the central server.

FIG. 4C depicts exemplary user interfaces for management of the user profile.

Interface 420 displays the vouchers within the user portfolio, along with related status, for example, vouchers for sale, vouchers being authenticated, purchased vouchers, and/or sold vouchers. Another tab allows the user to enter personal details.

Interface 422 displays details of a specific voucher.

Interface 424 displays a message due to lack of vouchers associated with the user, for example, “You don't have any vouchers. Do you want to purchase any? Do you want to sell any?”

Interface 426 allows the user to enter personal details, for example, name, phone number, and email.

For exemplary purposes, the United States dollar is used as an exemplary currency. Other currencies may be substituted in the examples, either for the same absolute value, or taking into account market currency exchange rates.

The methods and/or systems described herein may allow users to exchange vouchers with each other, and/or to exchange a voucher with another desirable item, instead of and/or in addition to money, for example, by payment processing module 312J or other modules. The buyer and/or seller may submit what they are looking to exchange. Certain buyers and/or sellers may opt to exchange vouchers instead of using cash, for example, to maintain the full face value of the voucher and/or item. As discussed herein, vouchers sold for money may be discounted off their face value.

Merchants may use the methods and/or systems described herein to purchase their own vouchers back at a discount, for example, the processing being performed by payment processing module 312J or another module. For example, a user receiving a $100 voucher for use at a merchant store after returning an item may be bought by the redeeming merchant at the discounted rate, for example, $90. The credit vouchers may be considered outstanding debt to consumers. Purchasing back the vouchers at the discounted rate may effectively lower the outstanding debt. Optionally, server 302 provides merchant 316 with a list of the outstanding vouchers available for sale. Alternatively or additionally, the system stores information regarding which users possess vouchers for which redeeming merchants. The redeeming merchants may clear the debt based on the outstanding vouchers by paying a clearance fee to the system. The system may use the clearance fee to purchase the outstanding vouchers from the users to reduce or eliminate the related outstanding debt of the redeeming merchant. The clearance fee is selected so that the system operator retains a profit after clearing the selected outstanding vouchers.

The availability of vouchers and/or voucher activity may be encouraged to be dynamic and/or fair, for example, to help match supply and/or demand. The number of outstanding vouchers and/or the value of vouchers may be manually controlled by an operator and/or automatically adjusted by server 302. For example, additional vouchers at different prices may be added, for example, vouchers previously bought by the system operator may now be made available for sale, by splitting vouchers, or by encouraging merchants to sell virtual coupons. The additional vouchers may encourage others to participate. For example, excess vouchers may be removed from sale, for example, by being purchased by the operator, by combination as described herein, or by encouraging merchants to buy back their own discounted vouchers. Removal of vouchers may encourage users to participate. Vouchers may be bought by the system at time periods with historical slow sales (for example, night time, holidays when stores are closed) to help encourage transactions during the slow periods. Available vouchers may be hidden from certain potential sellers, which may change the perceived supply and/or demand for the vouchers. For example, only one voucher from multiple similar vouchers may be presented to the user for purchase. In this manner, buying and/or selling activity may be encouraged, as the buyers and/or sellers may perceive reduced remand and/or reduced supply.

Optionally, buying of the voucher by the user and/or investor is performed based on an automatic buyer agent module, which may reside, for example, on mobile device 306, server 302, or other network connected computer. Purchases of the vouchers may be automatically performed based on a predefined set of rules defining the purchases of vouchers, for example, the geographic location(s) of the merchant(s), the redeeming merchant(s), the face value of the voucher (or range thereof), the discount rate (or range thereof), the discounted price (or range thereof), the time to purchase (or range thereof), and/or the date to purchase (or range thereof). In this manner, the programmed automatic buyer agent may purchase certain desired vouchers (for example, at a bargain) as soon as such vouchers become available. The set of rules may be entered by the user using interface module 310A.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant digital representations, mobile devices, geographical position devices, servers and/or databases will be developed and the scope of the terms digital representations, mobile devices, geographical position devices, servers and/or databases is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computerized method for location based purchase of merchant credit vouchers, comprising:
gathering via a network and at at least one server, a plurality of images each of one of a plurality of merchant credit vouchers, said plurality of images are uploaded using a plurality of mobile devices, each one of said plurality of merchant credit vouchers includes a store credit created based on a returned store item;
executing, a code at least one hardware processor of said at least one server for:
automatically extracting details of each of said plurality of merchant credit vouchers by an analysis of said plurality of images;
mapping according to said details each respective merchant credit voucher to at least one geographical redeeming area, wherein the plurality of merchant credit vouchers mapped to geographical redeeming areas are stored in a database;
receiving a geographical location of a user, the geographical location received from a mobile client terminal of the user;
matching the user geographical location to a certain geographical redeeming area from the geographical redeeming areas within the database to identify a group of merchant credit vouchers redeemable with at least one merchant located within the geographical redeeming area of the user;
instructing a transmission of the identified group of merchant credit vouchers from the central server to the mobile client of the user;
receiving, at the central server, a purchase order for purchase of at least one of the merchant credit vouchers from the group; and
transmitting a digital representation of the purchased at least one merchant credit voucher to the mobile client terminal for payment by the user at the merchant;
sending instructions to credit an account of a seller of the purchased at least one merchant credit voucher after the transmission of the digital representation.

2-3. (canceled)

4. The method of claim 1, wherein the group of identified merchant credit vouchers is transmitted to the user as the user is located within a shopping complex including a plurality of merchants having physical stores, the list including at least some credit vouchers redeemable at respective merchants of the plurality of merchants within the shopping complex.

5. The method of claim 1, wherein transmitting the group is performed using a push notification application to the mobile client.

6. The method of claim 1, further comprising analyzing changes in the geographical location of the user, and generating different groups of credit vouchers for merchants in shopping proximity to the user as the user changes locations.

7. The method of claim 1, wherein the group includes at least one merchant credit voucher owned by the user, and further comprising transmitting a reminder alert to the user to shop using the respective user owned at least one merchant credit voucher when the user is in shopping proximity to the respective merchant.

8. The method of claim 1, wherein the group includes at least one merchant credit voucher owned by the user, and further comprising transmitting a reminder alert to the user to shop using the respective user owned at least one merchant credit voucher based on the expiration date, to remind the user to redeem the credit voucher before expiration.

9. The method of claim 1, wherein the group includes at least one merchant credit voucher offered for sale by the respective merchant, at the physical store of the respective merchant in shopping proximity to the user.

10-11. (canceled)

12. The method of claim 1, wherein matching further comprises identifying at least one merchant credit voucher redeemable with at least one merchant located in shopping proximity to said user based on a user preference shopping profile, so that the at least one merchant includes items of interest to the user based on the user preference shopping profile.

13. The method of claim 1, wherein matching further comprises identifying at least one merchant credit voucher redeemable with at least one merchant located in shopping proximity to said user based on an analysis of at least one social network the user has joined, so that the at least one merchant includes items of interest to the user based on the analyzed at least one social network.

14. (canceled)

15. The method of claim 1, further comprising analyzing the geographical location as an orientation vector pointing along the user's walking path to a store location of said at least one merchant.

16. The computerized method of claim 1, further comprising:
receiving, a geographical location of the seller from a mobile client terminal of the seller;
analyzing the geographical location of the user and the seller to determine concurrent geographical locations in shopping proximity of the user and the seller, and sending a message to the user and the seller to arrange a face to face meeting between the user and seller for purchase of a physical version of the at least one merchant credit voucher.

17. The computerized method of claim 16, wherein the geographical location of the seller is received and analyzed at one or both of the central server and the mobile client terminal of the user.

18. The computerized method of claim 1, wherein the digital representation is generated from one of said plurality of images; wherein each one of said plurality of images digitally images a paper based version of the at least one merchant credit voucher.

19. (canceled)

20. The computerized method of claim 1, further comprising:
analyzing the geographical location of the user to determine the location of the user within a physical store of a merchant or in front of the physical store; and
matching to identify at least one merchant credit voucher redeemable at a competitor of the merchant, the competitor located in shopping proximity to said user, wherein the at least one merchant credit voucher is stored in the database of the plurality of merchant credit vouchers being offered for sale.

21. (canceled)

22. The computerized method of claim 1, further comprising debiting an account of the user after verifying proper receipt of the voucher.

23-24. (canceled)

25. The computerized method of claim 1, wherein the geographical location includes a navigation route and end target destination provided by a navigation application on the mobile device of the user, and the matching is performed based on geographical location areas along the navigation route and end target destination.

26. A system for location based sale of merchant credit vouchers, comprising:
a network interface adapted for gathering, via a network, and a plurality of images each of one of a plurality of merchant credit vouchers, said plurality of images are uploaded using a plurality of mobile devices, each one of said plurality of merchant credit vouchers includes a store credit created based on a returned store item,
a memory which stores a code;
a credit voucher database storing a plurality of merchant credit vouchers of a plurality of sellers, wherein each respective merchant credit voucher is mapped to at least one geographical redeeming area;
at least one hardware processor
coupled to the memory, the network interface, and the credit voucher database for executing said code, wherein said code comprises:
code instructions for automatically extracting details of each of said plurality of merchant credit vouchers by an analysis of said plurality of images;
code instructions for receiving a geographical location of a user, the geographical location received from a mobile client terminal of the user;
code instructions for matching, based on the user geographical location and said details, between a certain geographical redeeming area from the geographical redeeming areas within the database and a group of merchant credit vouchers redeemable with at least one merchant located within the geographical redeeming area of the user;
code instructions for transmitting to the mobile client terminal of the user, the group of merchant credit vouchers;
code instructions for receiving a purchase order for purchase of at least one of the merchant credit vouchers from the group;
code instructions for transmitting a digital representation of the purchased at least one merchant credit vouchers to the mobile client terminal for payment by the user at the merchant; and
code instructions for crediting an account of the seller of the purchased at least one merchant credit voucher after the transmission of the digital representation.

27. The system of claim 26, further comprising a user interface for installation on the mobile client terminal, the user interface configured to communicate with the system to transmit the geographical location and the purchase order, and to receive the list and the digital representation.

28-31. (canceled)

32. The system of claim 26, wherein said code further comprises code instructions for communicating with the at least one merchant stored in a database of a plurality of merchants, the merchant interface requesting re-issuance of a new identification of the credit voucher after sale, and assignment of cancellation status to the pre-sale credit voucher; wherein the re-issuance is configured to prevent fraud due to double-usage of the credit voucher.

33-41. (canceled)

42. The system of claim 26, wherein said code further comprises code instructions:
to provide to a certain redeeming merchant information regarding which users possess vouchers for the respective redeeming merchants, the user possessed vouchers denoting a debt of the certain redeeming merchant;
to receive from the redeeming merchant a clearance fee; and
to clear or reduce the debt by using the clearance fee to purchase the user possessed vouchers.

43-44. (canceled)

45. The system of claim 26, wherein said code further comprises code instructions to dynamically adjust the sale price of the voucher so that the sale price is automatically incrementally reduced as the expiration date nears.

46. The system of claim 26, wherein said code further comprises code instructions to select a price for friends based on social connections of the user based on an analysis of one or more social networks the user has joined, the price for friends selected to be lower than an estimated market price for the voucher being sold.

47. The system of claim 46, wherein the same voucher being sold is presented with the price for friends to mobile devices of social connections of the user and presented with the estimated market price to mobile devices of other potential buyers.

48. The system of claim 26, wherein said code further comprises code instructions to automatically purchase at least one voucher based on user selected predefined set of rules.
